(19) United States
(12) Patent Application Publication
(10) Pub. No.: US 2006/0058455 A1
(43) Pub. Date: Mar. 16, 2006

(54) Polyurethane elastomers having improved antistatic behavior

(76) Inventors: Erhard Michels, Koln (DE); Volker Schwob, Jaderberg (DE)

Correspondence Address: BAYER MATERIAL SCIENCE LLC, 100 BAYER ROAD, PITTSBURGH, PA, 15205, US

(21) Appl. No.: 11/211,899

(22) Filed: Aug. 25, 2005

(30) Foreign Application Priority Data
Aug. 31, 2004 (DE) 102004042033.5

(51) Int. Cl. C08G 18/08

(52) U.S. Cl. 524/589

(57) ABSTRACT

Polyurethane elastomers having improved behavior towards antistatic charge are produced by including an antistatic component in the polyurethane-forming reaction mixture. The antistatic component includes at least one quaternary alklyammonium monoalkylsulfate corresponding to a specified formula and at least one compound selected from (i) linear, OH-group-free dicarboxylic acid esters corresponding to a specified formula and/or (ii) a specified group of lactones. These polyurethane elastomers are particularly useful for the production of rollers, spring elements, mats and cushions, safety components in motor vehicles, shoe soles and shoe components.

### BACKGROUND OF THE INVENTION

The invention relates to polyurethane elastomers (PUR elastomers) having improved behavior towards antistatic charge and to processes for their preparation and use.

Semi-rigid, resilient polyurethane moldings in compact form or cellular (that is, lightly foamed) form are composed both on the basis of polyester-polyurethane compositions and on the basis of polyether urethane compositions. In order to improve the electrostatic discharge of these materials, additives having antistatic action are added to the polyether urethane compositions.

Additives known to be useful as antistatic agents include the tetraalkylammonium alkyl sulfates (See, e.g., Polyurethane Handbook, Günther Oertel, Carl Hanser Verlag, 2nd edition 1993), which are added to the PUR reaction compositions either in the form of a concentrate or in the form of a solution, preferably in ethylene glycol or 1,4-butanediol.

Alkylammonium sulfates are particularly suitable because they do not actively influence the polyurethane reaction and typical secondary reactions, such as polyurea and allophanate formation.

EP-A 1 336 639 discloses the use of quaternary ammonium compounds as internal antistatic agents for two-component polyurethanes. They are used in amounts of from 0.5 to 3.0 wt. %, based on the total weight of the polyurethane. In order to lower the melting range of the ammonium compounds, compounds that lower the melting point, such as, for example, butyrolactone, are added.

These additives have the disadvantage, however, that they must in some cases be added in large amounts to the PUR composition in order to achieve low antistatic values. Because they are present as a “filler” in the PUR matrix, the resilience and strength of the PUR are impaired as their content increases.

### SUMMARY OF THE INVENTION

The object of the present invention is to improve the action of tetraalkylammonium alkyl sulfates as antistatics in PUR foam so that either the amount of that additive can be reduced while maintaining the antistatic values, or lower (i.e., better) antistatic values are achieved while the amount used is the same.

It has been found, surprisingly, that the antistatic action of tetraalkylammonium alkyl sulfates can be markedly improved by the simultaneous addition of particular compounds described more fully herein. It has been possible to achieve a double to five-fold increase in the electrostatic discharge effect.

### DETAILED DESCRIPTION OF THE INVENTION

The present invention produces polyurethane elastomers by reacting
a) at least one di- and/or poly-isocyanate with
b) at least one polyester polyol having an OH number of from about 20 to about 280, preferably from about 28 to about 150, and a mean functionality of from about 1.5 to about 3, preferably from about 1.8 to about 2.4,
c) optionally, at least one polyether polyol having an OH number of from about 10 to about 150 and a functionality of from about 1.5 to about 8.0, preferably from about 1.8 to about 6.0, and/or at least one polyether ester polyol having an OH number of from about 20 to about 280 and a functionality of from about 1.5 to about 3.0, preferably from about 1.8 to about 2.4,
d) optionally, at least one low molecular weight chain extender and/or crosslinker having an OH numbers of from about 150 to about 1870,
   in the presence of
e) at least one amine and/or organometallic catalyst,
f) an antistatic component which includes:
   f1) at least one quaternary alkylammonium monoalkyl sulfate represented by formula (1)
      R¹R²R³R⁴N⁺R⁵SO₄⁻ (I)
   in which
   R¹, R², R³ and R⁴, independently of one another, each represents a C₁- to C₂₀-alkyl radical, the total number of carbon atoms in the four radicals not exceeding 70, and
   R₅ represents a C₂- to C₁₀-alkyl radical and
   f2) at least one compound selected from the following groups:
      i) at least one linear, OH-group-free dicarboxylic acid ester represented by formula (II) 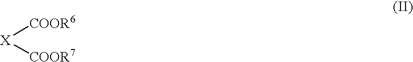
      in which
      X represents a radical having from 1 to 20 carbon atoms or represents a bond, and
      R⁶ and R⁷, independently of one another, each represents a C₁-to C₂₀-alkyl radical,
      ii) at least one lactone selected from the following group: γ-butyrolactone, γ-valerolactone, α,γ-, β,γ- and γγ-dimethylbutyrolactone and
      iii) mixtures of (i) and (ii),
g) optionally, at least one blowing agent and
h) optionally, at least one additive and/or auxiliary substance.

The quaternary alkylammonium alkyl sulfates f1) are present in an amount of from 0.5 to 15 wt. %, based on the polyurethane elastomer, and the compounds f2) are present in an amount of from 1.5 to 7.5 wt. %.

The invention further provides molded articles based on the polyurethane elastomers according to the invention.

The PUR elastomers of the present invention are preferably prepared by a prepolymer process in which a polyaddition adduct having isocyanate groups is expediently prepared in a first step from at least a portion of the polyester polyol b) or a mixture of polyester polyol b) with polyol component c) and at least one di- or poly-isocyante a). In a second step, PUR elastomers having adjusted antistatic behavior can be prepared from such prepolymers having unreacted isocyanate groups by reaction with any residual portion of the polyol component b) and/or optionally, component c) and/or optionally, low molecular weight chain extenders and/or crosslinkers d) and/or catalysts e). Component f) is preferably mixed with the polyol b). Microcellular PUR elastomers having a mold density of from 200 to 1200 kg/m³ can be prepared by adding blowing agent g) to the polyol b) in the second step.

The moldings produced from the PUR elastomers of the present invention have antistatic properties in the range of from 100 kOhm to 1000 M Ohm (measured in accordance with EN 344), depending on the content of f).

For the preparation of the PUR elastomers according to the invention, the components are reacted in amounts such that the equivalent ratio of the NCO groups of the polyisocyanates a) to the sum of the isocyanate-group-reactive hydrogens of components b), c), d) and any chemically active blowing agents that have been used is from 0.8:1 to 1.2:1, preferably from 0.90:1 to 1.15:1 and more preferably, from 0.95:1 to 1.05:1.

Suitable starting isocyanate components a) for the process according to the invention include: aliphatic, cycloaliphatic, araliphatic, aromatic and heterocyclic polyisocyanates, such as those described, for example, by W. Siefken in Justus Liebigs Annalen der Chemie, 562, pages 75 to 136. Examples of suitable isocyanates include those represented by the formula
Q(NCO)ₙ
in which n=from 2 to 4, preferably 2, and Q represents an aliphatic hydrocarbon radical having from 2 to 18 carbon atoms, preferably from 6 to 10 carbon atoms; a cycloaliphatic hydrocarbon radical having from 4 to 15 carbon atoms, preferably from 5 to 10 carbon atoms; an aromatic hydrocarbon radical having from 6 to 15 carbon atoms, preferably from 6 to 13 carbon atoms; and an araliphatic hydrocarbon radical having from 8 to 15 carbon atoms, preferably from 8 to 13 carbon atoms. Specific examples of such isocyanates include: ethylene diisocyanate, 1,4-tetramethylene diisocyanate, 1,6-hexamethylene diisocyanate (HDI), 1,12-dodecane diisocyanate, cyclobutane-1,3-diisocyanate, cyclohexane-1,3- and -1,4-diisocyanate and any desired mixtures of those isomers; 1-isocyanato-3,3,5-trimethyl-5-isocyanatomethyl-cyclohexane, 2,4- and 2,6-hexahydrotoluene diisocyanate and any desired mixtures of those isomers; hexahydro-1,3- and -1,4-phenylene diisocyanate; perhydro-2,4′- and -4,4′-diphenylmethane diisocyanate; 1,3- and 1,4-phenylene diisocyanate; 1,4-durene diisocyanate (DDI); 4,4′-stilbene diisocyanate; 3,3′-dimethyl-4,4′-biphenylene diisocyanate (TODI); 2,4- and 2,6-toluene diisocyanate (TDI) and any desired mixtures of those isomers; diphenylmethane-2,4′- and/or -4,4′-diisocyanate (MDI); and naphthylene-1,5-diisocyanate (NDI).

Also suitable are: triphenylmethane-4,4′-4″-triisocyanate; polyphenyl-polymethylene polyisocyanates such as those obtained by aniline-formaldehyde condensation and subsequent phosgenation and described, for example, in GB-PS 874 430 and GB-PS 848 671; m- and p-isocyanatophenylsulfonyl isocyanates according to, e.g., U.S. Pat. No. 3,454,606; perchlorinated aryl polyisocyanates such as those described in U.S. Pat. No. 3,277,138; polyisocyanates having carbodiimide groups such as those described in U.S. Pat. No. 3,152,162 and in DE-A 25 04 400, 25 37 685 and 25 52 350; norbornane diisocyanates such as those disclosed in U.S. Pat. No. 3,492,301; polyisocyanates having allophanate groups such as those described in GB-PS 994 890, BE-PS 761 626 and NL-A 7 102 524; polyisocyanates having isocyanurate groups such as those described in U.S. Pat. No. 3,001,9731, in DE-C 10 22 789, 12 22 067 and 1 027 394 and in DE-A 1 929 034 and 2 004 048; polyisocyanates having urethane groups, as are described, for example, in BE-PS 752 261 and in U.S. Pat. No. 3,394,164 and 3,644,457; polyisocyanates having acylated urea groups such as those disclosed in DE-C 1 230 778; polyisocyanates having biuret groups such as those described in U.S. Pat. Nos. 3,124,605, 3,201,372 and 3,124,605 and in GB-PS 889 050; polyisocyanates prepared by telomerization reactions such as those described in U.S. Pat. No. 3,654,106; polyisocyanates having ester groups such as those disclosed in GB-PS 965 474 and 1 072 956, in U.S. Pat. No. 3,567,763 and in DE-C 12 31 688; reaction products of the above-mentioned isocyanates with acetals as disclosed in DE-C 1 072 385; and polyisocyanates containing polymeric fatty acid esters such as those disclosed in U.S. Pat. No. 3,455,883.

It is also possible to use the isocyanate-group-containing distillation residues obtained in the industrial production of isocyanates, optionally dissolved in one or more of the above-mentioned polyisocyanates. It is also possible to use any desired mixtures of the above-mentioned polyisocyanates.

Preference is given to the use of the polyisocyanates that are readily obtainable industrially, for example 2,4- and 2,6-toluene diisocyanate and any desired mixtures of those isomers (“TDI”); 4,4′-diphenylmethane diisocyanate, 2,4′-diphenylmethane diisocyanate, 2,2′-diphenylmethane diisocyanate and polyphenyl-polymethylene polyisocyanates, such as those prepared by aniline-formaldehyde condensation and subsequent phosgenation (“crude MDI”); and polyisocyanates having carbodiimide groups, uretonimine groups, urethane groups, allophanate groups, isocyanurate groups, urea groups or biuret groups (“modified polyisocyanates”), especially those modified polyisocyanates which are derived from 2,4- and/or 2,6-toluene diisocyanate or from 4,4′- and/or 2,4′-diphenylmethane diisocyanate. Naphthylene-1,5-diisocyanate and mixtures of the mentioned polyisocyanates are also very suitable.

In the practice of the present invention, however, particular preference is given to the use of prepolymers having isocyanate groups, which prepolymers are prepared by reacting at least a portion of the polyester polyol b) or at least a portion of a mixture of polyester polyol b), polyol component c) and/or chain extenders and/or crosslinkers d) with at least one aromatic diisocyanate from the group TDI, MDI, TODI, DIBDI, NDI, DDI, preferably with 4,4′-MDI and/or 2,4-TDI and/or 1,5-NDI, to form a polyaddition product having urethane groups and isocyanate groups and having an NCO content of from 10 to 27 wt. %, preferably from 12 to 25 wt. %.

As already mentioned, it is possible to use mixtures of b), c) and d) in the preparation of the prepolymers having isocyanate groups. However, prepolymers having isocyanate groups prepared without chain extenders or crosslinkers d) are particularly preferred.

The prepolymers having unreacted isocyanate groups can be prepared in the presence of catalysts. However, it is also possible to prepare the prepolymers having isocyanate groups in the absence of catalysts and to incorporate catalysts into the reaction mixture only for the preparation of the PUR elastomers.

Suitable polyester polyols b) can be prepared, for example, from organic dicarboxylic acids having from 2 to 12 carbon atoms, preferably aliphatic dicarboxylic acids having from 4 to 6 carbon atoms, and polyhydric alcohols, preferably diols, having from 2 to 12 carbon atoms, preferably from 2 to 10 carbon atoms.

Suitable dicarboxylic acids include: succinic acid, malonic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used either individually or in the form of a mixture with one another. Instead of the free dicarboxylic acids, it is also possible to use the corresponding dicarboxylic acid derivatives, such as, dicarboxylic acid monoesters and/or diesters of alcohols having from 1 to 4 carbon atoms, and/or dicarboxylic acid anhydrides. Preference is given to the use of dicarboxylic acid mixtures of succinic, glutaric and adipic acid in relative proportions of, for example, 20 to 35/35 to 50/20 to 32 parts by weight; sebacic acid; and especially, adipic acid.

Examples of suitable di- and poly-hydric alcohols are: ethanediol, diethylene glycol, 1,2- and 1,3-propanediol, dipropylene glycol, methyl-1,3-propanediol, 1,4-butanediol, 1,5-pentanediol, 1,6-hexanediol, neopentyl glycol, 1,10-decanediol, glycerol, trimethylolpropane and pentaerythritol. Preference is given to the use of 1,2-ethanediol, diethylene glycol, 1,4-butanediol, 1,6-hexanediol, glycerol, trimethylolpropane and mixtures of at least two of the mentioned diols, especially mixtures of ethanediol, 1,4-butanediol and 1,6-hexanediol, glycerol and/or trimethylolpropane. It is also possible to use polyester polyols of lactones, for example ε-caprolactone, or hydroxycarboxylic acids, for example o-hydroxycaproic acid and hydroxyacetic acid.

For the preparation of the polyester polyols, the organic, for example aromatic and preferably aliphatic, polycarboxylic acids and/or polycarboxylic acid derivatives and the polyhydric alcohols can be subjected to polycondensation without a catalyst or in the presence of an esterification catalyst (expediently in an atmosphere of inert gases, such as nitrogen, carbon monoxide, helium, and/or argon) in solution and also in the melt, at temperatures of from 150 to 300° C., preferably from 180 to 230° C., optionally under reduced pressure, until the desired acid number is reached, which is advantageously less than 10, preferably less than 1.

In a preferred preparation process, the esterification mixture is subjected to polycondensation at the above-mentioned temperatures to an acid number of from 80 to 30, preferably from 40 to 30, under normal pressure and then under a pressure of less than 500 mbar, preferably from 10 to 150 mbar. Suitable esterification catalysts include: iron, cadmium, cobalt, lead, zinc, antimony, magnesium, titanium and tin catalysts in the form of metals, metal oxides or metal salts. The polycondensation may, however, also be carried out in the liquid phase in the presence of diluents and/or entrainers, such as benzene, toluene, xylene or chlorobenzene, for the azeotropic distillation of the water of condensation.

For the preparation of the polyester polyols, the organic polycarboxylic acids and/or their derivatives are subjected to polycondensation with polyhydric alcohols advantageously in a molar ratio of from about 1:1 to about 1.8, preferably from about 1: 1.05 to about 1.2:1. The resulting polyester polyols preferably have a functionality of from about 1.5 to about 3, preferably from about 1.8 to about 2.4, and a number-average molecular weight of from 300 to 8400, preferably from 400 to 6000, especially from 800 to 3500.

Polyether polyols and/or polyether ester polyols c) are optionally used in the preparation of the elastomers according to the invention. Polyether polyols can be prepared by any of the known processes, for example, by anionic polymerization of alkylene oxides in the presence of alkali hydroxides or alkali alcoholates as catalysts and with the addition of at least one starter molecule that contains from about 2 to about 3 reactive hydrogen atoms bonded therein, or by cationic polymerization of alkylene oxides in the presence of Lewis acids such as antimony pentachloride or boron fluoride etherate. Suitable alkylene oxides contain from 2 to 4 carbon atoms in the alkylene radical. Examples include: tetrahydrofuran, 1,2-propylene oxide, 1,2- and 2,3-butylene oxide, with preference being given to the use of ethylene oxide and/or 1,2-propylene oxide. The alkylene oxides can be used individually, alternately in succession, or in the form of mixtures. Mixtures of 1,2-propylene oxide and ethylene oxide are preferably used, with the ethylene oxide being used in an amount of from 10 to 50% to form of an ethylene oxide end block (“EO-cap”), so that the resulting polyols contain over 70% primary OH end groups. Suitable starter molecule for the polyether polyol include: water and di-tri-hydric alcohols, such as ethylene glycol, 1,2-propanediol and 1,3-propanediol, diethylene glycol, dipropylene glycol, 1,4-ethanediol, glycerol, trimethylolpropane, etc. Suitable polyether polyols, preferably polyoxypropylene-polyoxyethylene polyols, have a functionality of from 1.5 to 8 and a number-average molecular weight of from 500 to 8000, preferably from 800 to 6000.

Also suitable as polyether polyols are polymer-modified polyether polyols, preferably graft polyether polyols, especially those based on styrene and/or acrylonitrile, which are prepared by in situ polymerization of acrylonitrile, styrene or, preferably, mixtures of styrene and acrylonitrile (e.g., in a weight ratio of from about 90:10 to about 10:90, preferably from about 70:30 to about 30:70) in the above-mentioned polyether polyols, as well as polyether polyol dispersions which contain as the disperse phase, usually in an amount of from 1 to 50 wt. %, preferably from 2 to 25 wt. %, one or more inorganic fillers, polyureas, polyhydrazides, polyurethanes containing tert.-amino groups bonded therein, and/or melamine.

In order to improve the compatibility of b) and c), it is also possible to use or add polyether ester polyols as c). These are obtained by propoxylation or ethoxylation of polyester polyols preferably having a functionality of from about 1.5 to about 3, more preferably, from about 1.8 to about 2.4, and a number-average molecular weight of from about 400 to about 6000, preferably from about 800 to about 3500.

However, such polyether esters c) can also be obtained by monoesterification of ether polyols of the type previously mentioned with any of the ester components to be used corresponding to those described under b). Such polyether esters preferably have a functionality of from about 1.5 to about 3, especially from about 1.8 to about 2.4, and a number-average molecular weight of preferably from about 400 to about 6000, more preferably from about 800 to about 3500.

For the preparation of the PUR elastomers according to the invention there may additionally be used as component d) low molecular weight difunctional chain extenders, tri- or tetra-functional crosslinkers, or mixtures of chain extenders and crosslinkers.

Such chain extenders and crosslinkers d) are used to modify the mechanical properties, especially the hardness, of the PUR elastomers. Suitable chain extenders include: alkanediols, dialkylene glycols and polyalkylene polyols. Suitable crosslinkers include: tri- or tetra-hydric alcohols and oligomeric polyalkylene polyols having a functionality of from 3 to 4. Such chain extenders and crosslinkers usually have molecular weights <800, preferably from about 18 to about 400 and more preferably, from about 60 to about 300. Preferred chain extenders are: alkanediols having from 2 to 12 carbon atoms, preferably 2, 4 or 6 carbon atoms, for example ethanediol, 1,6-hexanediol, 1,7-heptanediol, 1,8-octanediol, 1,9-nonanediol, 1,10-decanediol and especially 1,4-butanediol; dialkylene glycols having from 4 to 8 carbon atoms, for example diethylene glycol and dipropylene glycol; and polyoxyalkylene glycols. Also suitable are branched-chain and/or unsaturated alkanediols usually having not more than 12 carbon atoms such as 1,2-propanediol, 2-methyl-1,3-propanediol, 2,2-dimethyl-1,3-propanediol, 2-butyl-2-ethyl-1,3-propanediol, 2-butene-1,4-diol and 2-butyne-1,4-diol; diesters of terephthalic acid with glycols having from 2 to 4 carbon atoms, such as terephthalic acid bis-ethylene glycol or terephthalic acid bis-1,4-butanediol; hydroxyalkylene ethers of hydroquinone or of resorcinol, for example 1,4-di-(β-hydroxyethyl)-hydroquinone or 1,3-(β-hydroxyethyl)-resorcinol; alkanolamines having from 2 to 12 carbon atoms, such as ethanolamine, 2-aminopropanol and 3-amino-2,2-dimethylpropanol; N-alkyldialkanolamines, for example, N-methyl- and N-ethyl-diethanolamine; (cyclo)aliphatic diamines having from 2 to 15 carbon atoms, such as 1,2-ethylenediamine, 1,3-propylenediamine, 1,4-butylenediamine and 1,6-hexamethylenediamine, isophoronediamine, 1,4-cyclohexamethylenediamine and 4,4′-diaminodicyclohexylmethane; N-alkyl-substituted, N,N′-dialkyl-substituted and aromatic diamines, which may also be substituted on the aromatic radical by alkyl groups, having from 1 to 20 carbon atoms, preferably from 1 to 4 carbon atoms, in the N-alkyl radical, such as N,N′-diethyl-, N,N′-di-sec.-pentyl-, N,N′-di-sec.-hexyl-, N,N′-di-sec.-decyl- and N,N′-dicyclohexyl-, (p- and m-)-phenylenediamine, N,N′-dimethyl-, N,N′-diethyl-, N,N′-diisopropyl-, N,N′-di-sec.-butyl-, N,N′-dicyclohexyl-, -4,4′-diamino-diphenylmethane, N,N′-di-sec.-butylbenzidine, methylene-bis(4-amino-3-benzoic acid methyl ester), 2,4-chloro-4,4′-diamino-diphenylmethane, and 2,4- and 2,6-toluenediamine.

These compounds can be used in the form of mixtures or individually as component d). The use of mixtures of chain extenders and crosslinkers is also possible.

In order to adjust the hardness of the PUR elastomers, the structural components b), c) and d) can be varied in broad relative proportions. The hardness increases as the content of component d) in the reaction mixture rises.

In order to obtain a desired hardness of the material, the required amounts of the structural components b), c) and d) can be determined in a simple manner by experiment. There are advantageously used in amounts of from 1 to 50 parts by weight, preferably from 3 to 20 parts by weight, of the chain extender and/or crosslinker d), per 100 parts by weight of the higher molecular weight compounds b) and c).

Any of the amine catalysts known to the person skilled in the art may be used as component e). Such catalysts include: tertiary amines, such as triethylamine, tributylamine, N-methyl-morpholine, N-ethyl-morpholine, N,N,N′,N′-tetramethyl-ethylenediamine, pentamethyl-diethylene-triamine and higher homologues (DE-A 26 24 527 and 26 24 528); 1,4-diaza-bicyclo-[2.2.2]-octane; N-methyl-N′-dimethylaminoethyl-piperazine; bis-(dimethylaminoalkyl)-piperazines; N,N-dimethylbenzylamine; N,N-dimethylcyclohexylamine; N,N-diethylbenzylamine; bis-(N,N-diethylaminoethyl) adipate; N,N,N′,N′-tetramethyl-1,3-butanediamine; N,N-dimethyl-p-phenyl-ethyl-amine; bis-(dimethylaminopropyl)-urea; 1,2-dimethylimidazole; 2-methylimidazole; monocyclic and bicyclic amidines; bis-(dialkylamino)alkyl ethers; and also tertiary amines having amide groups (preferably formamide groups) according to DE-A 25 23 633 and 27 32 292. Suitable catalysts also include known Mannich bases of secondary amines, such as dimethylamine; and aldehydes, preferably formaldehyde; ketones, such as acetone, methyl ethyl ketone or cyclohexanone; and phenols, such as phenol, nonylphenol or bisphenol. Tertiary amine catalysts containing hydrogen atoms active towards isocyanate groups include: triethanolamine, triisopropanolamine, N-methyl-diethanolamine, N-ethyl-diethanolamine, N,N-dimethyl-ethanolamine, reaction products thereof with alkylene oxides, such as propylene oxide and/or ethylene oxide, as well as secondary-tertiary amines according to DE-A 27 32 292. It is also possible to use as catalysts silamines having carbon-silicon bonds, such as those described in U.S. Pat. No. 3,620,984, for example 2,2,4-trimethyl-2-silamorpholine and 1,3-diethyl-aminomethyl-tetramethyl-disiloxane. Nitrogen-containing bases, such as tetraalkylammonium hydroxides, and also hexahydrotriazines may also be used as catalysts. The reaction between NCO groups and Zerewitinoff-active hydrogen atoms is also greatly accelerated by lactams and azalactams. According to the invention, the concomitant use of organic metal compounds, especially organic tin compounds, as additional catalysts is also possible. Suitable organometallic compounds having catalytic activity are, in addition to tin derivatives, the sulfur-containing compounds such as di-n-octyl-tin mercaptide, preferably tin(II) salts of carboxylic acids, such as tin(II) acetate, tin(II) octoate, tin(II) ethylhexoate and tin(II) laurate, and tin(IV) compounds, for example dibutyltin oxide, dibutyltin dichloride, dibutyltin diacetate, dibutyltin dilaurate, dibutyltin maleate and dioctyltin diacetate, as well as titanium-containing compounds, such as titanium and bismuth alcoholates and carboxylates.

The catalysts or catalyst combinations are generally used in an amount of from approximately 0.001 to 10 wt. %, preferably, from 0.01 to 1 wt. %, based on the total amount of compounds having at least two hydrogen atoms reactive towards isocyanates.

In component f), the materials useful as f1) include any of the quaternary alkylammonium monoalkyl sulfates known to the person skilled in the art in which the four alkyl radicals associated with the ammonium cation have, independently of one another, a chain length of from 1 to 20 carbon atoms and may be present in linear, branched or partly cyclic form and may have, in sum, a total content of up to and including 70 carbon atoms. The alkyl radical of the sulfate anion may have a chain length of from 2 to 5 carbon atoms.

In component f), the compounds useful as (i) of component (f2) include alkyl esters of oxalic acid, malonic acid, maleic acid, fumaric acid, succinic acid, glutaric acid, adipic acid, suberic acid, azelaic acid, sebacic acid, and/or decanedicarboxylic acid. Aliphatic and alicyclic monools, such as methanol, ethanol, propanol, isopropanol, butanol, hexanol, ethylenehexanol, octanol, decanol and dodecanol and also cyclohexanol, as well as their isomers, and also aryl alcohols, such as phenol and its alkyl-substituted derivatives, and naphthol and its alkyl-substituted derivatives are useful for the esterification of the dicarboxylic acids.

Compounds (ii) of component (f2) include γ-butyrolactone, γ-valerolactone, α,γ-, β,γ- and γγ-dimethylbutyrolactone and mixtures thereof.

The process of the present invention makes it possible to prepare compact PUR elastomers, for example PUR casting elastomers in the absence of moisture and blowing agent.

For the preparation of cellular, preferably microcellular, PUR elastomers, a blowing agent g) is used. The preferred blowing agent is water, which reacts in situ with the organic polyisocyanates a) or with prepolymers having isocyanate groups to form carbon dioxide and amino groups, which in turn react further with other isocyanate groups to form urea groups and thus act as chain extenders.

Where water is added to the polyurethane formulation in order to establish the desired density, it is usually used in amounts of from 0.001 to 3.0 wt. %, preferably from 0.01 to 2.0 wt. % and especially from 0.05 to 0.8 wt. %, based on the weight of the structural components a), b) and optionally, c) and/or d).

Instead of water, or preferably in combination with water, it is possible to use as the blowing agent g) gases or readily volatile inorganic or organic substances, which evaporate under the effect of the exothermic polyaddition reaction and preferably have a boiling point under normal pressure in the range of from −40 to 120° C., preferably from 10 to 90° C., as physical blowing agents. Suitable organic blowing agents include: acetone, ethyl acetate, halo-substituted alkanes or perhalogenated alkanes (e.g., R134a, R141b, R365mfc, R245fa), also butane, pentane, cyclopentane, hexane, cyclohexane, heptane and diethyl ethers. Suitable inorganic blowing agents include: air, CO₂ and/or N₂O. A blowing action can also be achieved by addition of compounds that decompose at temperatures above room temperature with the liberation of gases (e.g., nitrogen and/or carbon dioxide) such as azo compounds, e.g. azodicarbonamide or azoisobutyric acid nitrile; or salts such as ammonium bicarbonate, ammonium carbamate or ammonium salts of organic carboxylic acids, for example the monoammonium salts of malonic acid, boric acid, formic acid or acetic acid. Further examples of blowing agents and details relating to the use of blowing agents are described in R. Vieweg, A. Höchtlen (eds.): “Kunststoff-Handbuch”, Volume VII, Carl-Hanser-Verlag, Munich, 3rd Edition, 1993, p. 115-118, 710-715.

The amount of solid blowing agent(s), low-boiling liquid(s) or gas(es) to be used, either individually or in the form of mixtures (e.g., in the form of liquid or gas mixtures or in the form of gas/liquid mixtures) depends on the desired density and the amount of water used. The required amounts can readily be determined by experiment. Satisfactory results are usually obtained with solid(s) in amounts of from 0.5 to 35 wt. %, preferably from 2 to 15 wt. %; with liquid(s) in amounts of from 0.5 to 30 wt. %, preferably from 0.8 to 18 wt. %; and/or with gas(es) in amounts of from 0.01 to 80 wt. %, preferably from 10 to 50 wt. %, in each case based on the weight of the structural components a), b), c) and d). Loading with gas (e.g., with air, carbon dioxide, nitrogen and/or helium) can be carried out (1) via the higher molecular weight polyhydroxyl compounds b) and c), (2) via the low molecular weight chain extender and/or crosslinker d) (3) via the polyisocyanates a) or (4) via a) and b) and optionally c) and d).

Additives h) may optionally be incorporated into the reaction mixture for the preparation of the compact and cellular PUR elastomers. Examples of suitable additives include: surface-active additives, such as emulsifiers; foam stabilizers; cell regulators; flameproofing agents; nucleating agents; oxidation retarders; stabilizers; lubricants and mold release agents; colorants; dispersion aids and pigments. Examples of suitable emulsifiers are the sodium salts of castor oil sulfonates and salts of fatty acids with amines, such as the oleate of diethylamine or the stearate of diethanolamine. Alkali or ammonium salts of sulfonic acids, such as, dodecylbenzenesulfonic acid or dinaphthylmethanedisulfonic acid, or of fatty acids, such as ricinoleic acid, or of polymeric fatty acids may also be used concomitantly as surface-active additives. Suitable foam stabilizers include polyether siloxanes, especially water-soluble examples thereof. The structure of these compounds is generally such that a copolymer of ethylene oxide and propylene oxide is bonded to a polydimethylsiloxane radical. Such foam stabilizers are described, for example, in U.S. Pat. No. 2,834,748, 2,917,480 and 3,629,308. Of particular interest are polysiloxane-polyoxyalkylene copolymers multiply branched via allophanate groups, according to DE-A 25 58 523. Also suitable are other organopolysiloxanes, ethoxylated alkylphenols, ethoxylated fatty alcohols, paraffin oils, castor oil and ricinoleic acid esters, Turkey-red oil, groundnut oil and cell regulators such as paraffins, fatty alcohols and polydimethylsiloxanes. Oligomeric polyacrylates having polyoxyalkylene and fluoroalkane radicals as side groups are also suitable for improving the emulsifying action, the dispersion of the filler, the cell structure and/or for the stabilization thereof. The surface-active substances are usually used in amounts of from 0.01 to 5 parts by weight, based on 100 parts by weight of the higher molecular weight polyhydroxyl compounds b) and c). It is also possible to add reaction retarders, pigments or colorings, and flameproofing agents known per se, as well as stabilizers against the effects of ageing and weathering, plasticizers, and substances having a fungistatic and bacteriostatic action.

Further examples of surface-active additives and foam stabilizers as well as cell regulators, reaction retarders, stabilizers, flame-retarding substances, plasticizers, coloring agents and fillers, as well as substances having a fungistatic and bacteriostatic action, which may optionally be used in practicing the present invention, and details relating to the use and mode of action of such additives are described in R. Vieweg, A. Höchtlen (eds.): “Kunststoff-Handbuch”, Volume VII, Carl-Hanser-Verlag, Munich, 3rd Edition, 1993, p. 1118-124.

The PUR materials according to the invention can be prepared according to the processes described in the literature, for example the one-shot process or the prepolymer process, with the aid of any of the mixing devices known to the person skilled in the art. They are preferably prepared according to the prepolymer process.

In one embodiment of the present invention, the PUR materials of the present invention are produced by homogeneously mixing the starting components in the absence of blowing agent(s) g), usually at a temperature of from 20 to 80° C., preferably from 25 to 60° C. The reaction mixture is then introduced into an open molding tool, optionally having a certain temperature, and allowed to cure. In another embodiment of the present invention, the structural components are mixed in the same manner as in the previous embodiment with the exception that the blowing agent(s) g), preferably water is/are present, and introduced into the molding tool, optionally having a certain temperature. After filling, the molding tool is closed and the reaction mixture is allowed to foam with compression, for example with a degree of compression (ratio of the density of the molded body to the density of the free foam) of from 1.05 to 8, preferably from 1.1 to 6 and more preferably, from 1.2 to 4, with the formation of molded articles. As soon as the molded article is sufficiently strong, it is removed from the mold. The mold removal times are dependent inter alia on the temperature and geometry of the molding tool and the reactivity of the reaction mixture and usually range from about 2 to about 15 minutes.

Compact PUR elastomers according to the invention have a density, dependent inter alia on the content and type of filler, of from 0.8 to 1.4 g/cm³, preferably from 0.9 to 1.20 g/cm³. Cellular PUR elastomers according to the invention have densities of from 0.2 to 1.4 g/cm³, preferably from 0.25 to 0.75 g/cm³.

Such polyurethane plastics are particularly valuable for the manufacture of antistatic footwear, especially for shoe soles according to EN 344 in single- or multi-layer form, and shoe components as well as rollers, spring elements, mats and cushions foamed in the mold, and safety components in motor vehicle construction.

### EXAMPLES

The polyurethane test specimens were prepared in each of the Examples given herein by the following procedure. The A component (at 45° C.) was mixed with the B component (at 45° C.) in a low-pressure foaming installation (NDI) at a mass ratio (MR) of Component A to Component B indicated in Table 1, the mixture was poured into an aluminum mold adjusted to a temperature of 50° C., the mold was closed, and the elastomer was removed after 3 minutes.

The electrostatic discharge resistance was measured on the elastomer sheets so prepared (density 550 kg/m³) after the storage time indicated in the Table. The measuring arrangement corresponded to that described in EN 344, Chapter 5.7. The test climate was 20° C. with 55% atmospheric humidity.

The materials used in the Examples were as follows:
Polyester polyol: Ethanediol-diethylene glycol-polyadipate (ratio 14.3:24.4:61.3) having a number-average molecular weight of 2000 g/mol.
Dabco/EG: Amine catalyst diaza-bicyclo[2.2.2]octane in ethylene glycol (weight ratio 1:2)
Antistatic A: 80% solution of trimethyl-dodecyl-ammonium ethyl sulfate in ethanediol
Surfactant DC 193: Silicone stabilizer Dabco DC193 from Air Products
B component: Prepolymer having an NCO content of 19%, obtained by reaction of:
   56 wt. % 4,4′-MDI
   6 wt. % polymeric MDI (29.8 wt. % NCO, functionality 2.1)
   38 wt. % ethanediol-diethylene glycol-polyadipate (ratio 14.3:24.4:61.3) having a number-average molar mass of 2000 g/mol

The composition and relative amounts of each reaction component used in each Example, foaming results and the results of the resistance measurement are reported in Table 1.

The numerical values in the Table are wt. % unless indicated otherwise.

| | 1* | 2 | 3 | 4* | 5 | 6 | 7* | 8 | 9 |
|---|---|---|---|---|---|---|---|---|---|
| Polyester polyol | 88.50 | 82.50 | 82.50 | 84.50 | 78.50 | 78.50 | 76.50 | 70.5 | 70.5 |
| Ethanediol | 6.00 | 6.00 | 6.00 | 6.00 | 6.00 | 6.00 | 6.00 | 6.00 | 6.00 |
| Dabco/EG | 0.90 | 0.90 | 0.90 | 0.90 | 0.90 | 0.90 | 0.90 | 0.90 | 0.90 |
| Water | 0.40 | 0.4 | 0.4 | 0.4 | 0.4 | 0.4 | 0.4 | 0.4 | 0.4 |
| Surfactant DC 193 | 0.20 | 0.20 | 0.20 | 0.20 | 0.20 | 0.20 | 0.20 | 0.20 | 0.20 |
| Antistatic A | 4.00 | 4.00 | 4.00 | 8.00 | 8.00 | 8.00 | 16.00 | 16.00 | 16.00 |
| Adipic acid dibutyl ester | — | — | 6.00 | — | — | 6.00 | — | — | 6.00 |
| gamma-Butyrolactone | — | 6.00 | — | — | 6.00 | — | — | 6.00 | — |
| Total | 100 | 100 | 100 | 100 | 100 | 100 | 100 | 100 | 100 |
| Mixture 100 parts by weight | 78.8 | 77.5 | 77.5 | 83.4 | 82.2 | 82.2 | 92.7 | 91.5 | 91.5 |
| polyol mixture to B component | | | | | | | | | |
| (parts by weight) | | | | | | | | | |
| Shore A (after 24 hours) | 50 | 46 | 46 | 45 | 45 | 40 | 40 | 35 | 35 |
| Volume resistance | | | | | | | | | |
| [MegaOhm]/% for comparison* | | | | | | | | | |
| 0.5 h after removal from mold | 92 | 18/19% | 36/39% | 34 | 8/23% | 12/35% | 7 | 1.2/17% | 5/71% |
| 16 h after removal from mold | 240 | 50/20% | 107/44% | 133 | 31/23% | 65/49% | 54 | 13/24% | 17/31% |
| 24 h after removal from mold | 72 | 18/25% | 44/61% | 50 | 13/26% | 23/46% | 19 | 5.5/29% | 7.7/40% |

*= comparison examples

The smaller the measured values for the volume resistance, the better the antistatic properties.

In Examples 2 and 3, 5 and 6, and 8 and 9, the increased effectiveness (i.e. lesser antistatic properties) in comparison with the respective comparative Examples 1, 4 and 7 can clearly be seen.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane elastomer comprising the reaction product of
a) a di- and/or poly-isocyanate with
b) at least one polyester polyol having an OH number of from 20 to 280, and a mean functionality of from 1.5 to 3,
c) optionally, a polyether polyol having an OH number of from 10 to 150 and a functionality of from 1.5 to 8.0 and/or a polyether ester polyol having an OH number of from 20 to 280 and a functionality of from 1.5 to 3.0, and
d) optionally, a low molecular weight chain extender and/or crosslinker having an OH number of from 150 to 1870,
in the presence of
e) an amine and/or organometallic catalyst,
f) an antistatic component comprising
f1) from about 0.5 to about 15 wt. %, based on total weight of the polyurethane elastomer of a quaternary alkylammonium monoalkyl sulfate represented by the formula
R¹R²R³R⁴N⁺R⁵SO₄⁻ (1)
in which
R¹, R², R³ and R⁴, independently of one another, each represents an alkyl radical having from 1 to 20 carbon atoms, with the total number of carbon atoms in these four radicals being no greater than 70, and
R⁵ represents an alkyl radical having from 2 to 10 carbon atoms, and
f2) from about 1.5 to about 7.5 wt. %, based on the total weight of the polyurethane elastomer, of at least one compound selected from the group consisting of
(i) linear, OH-group-free dicarboxylic acid esters represented by the formula 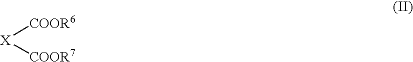
in which
X represents a radical having from 1 to 20 carbon atoms or represents a bond, and
R⁶ and R⁷, independently of one another, each represents an alkyl radical having from 1 to 20 carbon atoms,
(ii) at least one lactone from the group consisting of γ-butyrolactone, γ-valerolactone, α,γ-, β,γ- and γγ-dimethylbutyrolactone and
(iii) mixtures of (i) and (ii),
g) optionally, a blowing agent and
h) optionally, an additive and/or auxiliary substance.

2. The polyurethane elastomer of claim 1 in which polyester polyol b) has a mean functionality of from 1.8 to 2.4.

3. The polyurethane elastomer of claim 1 in which the polyester polyol b) has an OH Number of from about 28 to about 150.

4. The polyurethane elastomer of claim 1 in which the polyether polyol has a functionality of from about 1.8 to about 6.

5. The polyurethane elastomer of claim 1 in which the polyether ester polyol c) has a functionality of from about 1.8 to about 2.4.

6. A molded article comprising the polyurethane elastomer of claim 1.

7. A roller produced from the polyurethane elastomer of claim 1.

8. A spring element produced from the polyurethane elastomer of claim 1.

9. A mat or cushion produced from the polyurethane elastomer of claim 1.

10. Motor vehicle safety components produced from the elastomer of claim 1.

11. Shoe soles and shoe components produced from the elastomer of claim 1.
